(19) United States
(12) Patent Application Publication
(10) Pub. No.: US 2026/0102980 A1
(43) Pub. Date: Apr. 16, 2026

(54) TOOLING AND METHOD FOR MANUFACTURING A COMPOSITE VANE FOR AN AIRCRAFT ENGINE

(71) Applicant: SAFRAN AIRCRAFT ENGINES, Paris (FR)

(72) Inventors: Maxime Marie Desire BLAISE, Moissy-Cramayel (FR); Nicolas DROZ, Moissy-Cramayel (FR); Pierre-Antoine BOSSAN, Moissy-Cramayel (FR)

(21) Appl. No.: 19/114,735

(22) PCT Filed: Sep. 18, 2023
(86) PCT No.: PCT/FR2023/051417

§ 371 Date: Mar. 24, 2025

(30) Foreign Application Priority Data
Sep. 26, 2022 (FR) FR2209717

(51) Int. Cl. B29C 70/48; B29C 33/02; B29L 31/08

(52) U.S. Cl. CPC B29C 70/48; B29C 33/02; B29L 2031/082

(57) ABSTRACT

A tooling for manufacturing a blade made of composite material for a turbomachine, in particular of an aircraft, including a mould and a counter-mould which define between them a cavity configured to receive a woven preform, the cavity having a first part configured to receive a shield and at least one edge of the preform, and a second part configured to receive at least part of the remainder of the preform, and elements for managing the temperature of the cavity, which elements are configured to heat the first and second parts of the cavity at different temperatures during at least one step of a method for manufacturing the blade.

### TECHNICAL SCOPE OF THE INVENTION

This invention relates to a tooling and a method for manufacturing a composite material vane for an aircraft turbomachine.

### TECHNICAL BACKGROUND

The prior art comprises in particular documents FR-A1-2 956 057, FR-A1-3 029 134, FR-A1-3 051 386 and EP-A2-2 353 830.

The use of composite materials is advantageous in the aerospace industry, particularly as these materials offer excellent mechanical performance at relatively low weight.

One method of manufacturing a composite part for the aerospace industry, which is well known to those skilled in the art, is the RTM molding process, the initials of which refer to the acronym Resin Transfer Molding.

This is a method for making a composite material part based on resin-impregnated fibers. Such a method is used, for example, to manufacture a fan vane and comprises several successive steps.

First, fibers are woven together to produce a three-dimensional preform blank, which is then cut to produce a preform substantially in the shape of the vane to be produced. This preform is then placed in a tooling comprising a mold and a counter-mold. The tooling is closed and liquid resin is injected, maintaining pressure on the injected resin while the part is polymerized by heating the tooling.

The resins used are very fluid resins that are able to penetrate the preform fibers well, even when injected under reduced pressure. During polymerization, under the effect of heat, the injected resin passes successively from the liquid state to the gelled state and finally to the solid state.

To manufacture a vane, for example for a turbomachine fan, a preform is woven in three dimensions and then is impregnated with resin to form a blade. This blade comprises a pressure side and a suction side extending from a leading edge to a trailing edge of the blade.

The composite material of the blade is relatively fragile, and in particular sensitive to impacts, and it is known to be protected by means of a metal shield which is attached and fixed to the leading edge of the blade.

The shield can be attached to the blade in several ways. The first one is to bond the shield to the blade after polymerization of the resin. The adhesive then takes the form of a paste or a film.

In today's technology, pairing the shields to the edges of the vanes is a key and demanding step in the manufacturing method. Indeed, shields are highly complex parts and can vary from one to another depending on the manufacturer and manufacturing tolerances and can therefore have different geometric features.

Before matching and bonding a shield to the edge of a vane, it is therefore necessary to ensure that the dimensions and shape of the shield match those of the vane in order to optimize the bonding surface and therefore the material health of the part once bonded (thickness of adhesive, porosity rate, etc.).

By dispensing with the bonding step and integrating it directly into the injection step, the geometry of the bonding interface is directly matched to the geometry of the vane edge at every point, thus eliminating the step consisting of finding the optimum shield/edge of the vane pairing. This also eliminates the need to prepare the surface of the vane prior to bonding. Last but not least, it means that additional passages in the heat treatment equipment (oven, autoclave, etc.) are no longer necessary.

Another way of attaching a shield to a blade, which involves attaching the shield by co-molding with the fiber preform has already been made. Adhesive is placed between the shield and the preform and the assembly is placed in the tooling. The injected resin impregnates the preform, and a curing and pressurization step ensures that the adhesive and resin are polymerized and hardened.

The curing cycle has to be adapted to take account of the physical properties and processing conditions of both the adhesive and the resin. This constraint calls for the development of a complex method that is difficult to industrialize.

A thermal compromise has to be found to guarantee the physical and chemical robustness of the method and the mechanical performance of the final assembly.

When it comes to the adhesive, for example, it is important to:
not degrade the rheology in order to ensure wetting on the surfaces to be bonded,
ensure that the viscosity is relatively high before applying pressure in the tooling, and
not prematurely age the adhesive at temperature to guarantee the final mechanical properties of the adhesive joint.

With regard to resin, it is important to:
ensure low viscosity to fill the tooling cavity and impregnate the preform, and therefore ensure sufficient temperature of the tooling, and
ensure that the rate of polymerization is as low as possible before applying pressure in the tooling.

The present invention offers an improvement on the current technique which provides a solution to at least part of the above-mentioned problems.

### SUMMARY OF THE INVENTION

The invention proposes a tooling for manufacturing a vane made of composite material for a turbomachine, in particular of an aircraft, this vane comprising a blade comprising a pressure side and a suction side which extend from a leading edge to a trailing edge of the blade, the vane also comprising a root and an upper edge opposite its root, the vane further comprising at least one metal shield extending along at least one of said edges of the blade, the tooling comprising:
a mold and a counter-mold which define between them a cavity configured to receive a woven preform of the blade, the cavity comprising a first portion configured to receive the shield and the edge or edges of the preform intended to receive this shield, and a second portion configured to receive at least part of the remainder of the preform,
at least one port for injecting resin into the cavity in order to impregnate said preform, and
elements for managing the temperature of the cavity,
characterized in that the temperature management elements comprise first elements for managing the temperature of the first portion of the cavity, and second elements for managing the temperature of the second portion of the cavity which are independent of the first temperature management elements so that the first and second management elements can heat the first and second portions of the cavity to different temperatures during at least one step of a method for manufacturing the vane.

The tooling according to the invention thus comprises independent temperature management elements which are configured to bring the first and second portions of the cavity respectively to temperature. It is therefore understood that the temperature of the portion of the cavity containing the edge or edges and the adhesive can be adapted to facilitate diffusion of the resin into the preform while avoiding accelerated ageing of the adhesive, and the temperature of the other portion of the cavity can be adapted to facilitate diffusion of the resin while optimizing the conditions for polymerization of this resin.

In this current application, temperature “management” means heating and/or cooling. The members are therefore capable of heating the tooling and the cavity and/or cooling the tooling and the cavity. By way of example, the first management members are heating and/or cooling members, and the second management members are heating members.

The tooling according to the invention may comprise one or more of the following features, taken in isolation from each other or in combination with one another:
the second temperature management elements are heating elements which are configured to heat the tooling to a predetermined temperature, T1;
the first temperature management elements are heating elements which are configured to heat the tooling to a predetermined temperature, noted T1, during a step of a manufacturing method, and to another predetermined temperature, noted T2 and lower than T1, during another step of the manufacturing method;
the first temperature management elements are cooling and heating elements which are configured to heat the tooling to a predetermined temperature, noted T1, during a step of a manufacturing method, and to cool the tooling to a predetermined temperature, noted T2 and lower than T1, during another step of the manufacturing method;
the cavity comprises an intermediate portion, located between the first and second portions, the temperature management elements being configured to create a zone of gradual temperature transition at this intermediate portion;
the temperature management elements are of the resistance heating, induction or heat transfer fluid circulation type;
the temperature management elements are distributed throughout the mold and counter-mold; and
the temperature management elements are integrated into the mold and the counter-mold; the first temperature management elements can be arranged at the first portion of the cavity, and the second temperature management elements can be arranged at the second portion of the cavity.

The invention also proposes a method of manufacturing a composite material vane for a turbomachine, in particular for an aircraft, this vane comprising a blade comprising a pressure side and a suction side which extend from a leading edge to a trailing edge of the blade, the vane also comprising a root and an upper edge opposite its root, the vane further comprising at least one metal shield extending along at least one of the said edges of the blade, the method using tooling as previously described and comprising the steps of:
a) arranging a shield and a preform made by weaving fibers in the cavity of the tooling, a polymerizable adhesive being interposed between the shield and the edge or edges of the preform intended to receive the shield, the shield and the edge or edges of the preform being positioned in the first portion of the cavity, and the remainder of the preform being positioned in the second portion of the cavity,
b) closing the tooling, and
c) managing the temperature of the tooling and injecting polymerizable resin into the cavity of the tooling so that it impregnates the preform to form the blade after solidification,
characterized in that step c) comprises:
c1) a first resin injection sub-step during which the second portion of the cavity is heated to a predetermined temperature, noted T1, and the first portion of the cavity is managed so as not to exceed a predetermined temperature, noted T2, which is lower than T1, and
c2) a second curing sub-step during which the first and second portions are heated to the temperature T1.

The method according to the invention may comprise one or more of the following steps or features, taken in isolation from one another or in combination with one another:
in sub-step c1), the first portion of the cavity is heated to the predetermined temperature T2; it is thus understood that this first portion passes from a temperature below T2 to the temperature T2, by heating;
in sub-step c1), the first portion of the cavity is cooled so as not to exceed the predetermined temperature T2; it is therefore understood that this first portion tends to heat up above T2 and is cooled so as not to exceed this temperature;
the temperature T1 is greater than or equal to 160° C., and preferably greater than or equal to 180° C., and the temperature T2 is between 80 and 140° C., and preferably between 100 and 130° C.;
the weaving of the preform is carried out in two dimensions or in three dimensions.

### BRIEF DESCRIPTION OF THE FIGURES

Further features and advantages of the invention will become apparent from the following detailed description, for the understanding of which reference is made to the appended drawings wherein:

FIG. 1 is a schematic view perspective of a composite aircraft turbomachinery vane,

FIG. 2 is a block diagram showing the steps of a method according to the invention for manufacturing a vane such as that shown in FIG. 1,

FIG. 3 is a schematic perspective view of a mold wherein a preform and a shield are to be arranged, and into which a resin is to be injected,

FIG. 4 is a graph showing the temperature evolution of a tooling for manufacturing a vane according to FIG. 1 over time, and illustrates two heating cycles,

FIG. 5 is a schematic cross-sectional view of a tooling according to one embodiment of the invention;

FIG. 6 is a schematic cross-sectional view of a tooling according to an alternative embodiment of the invention; and

FIG. 7 is a graph showing the change in temperature of a tooling for manufacturing a vane as shown in FIG. 1 over time and illustrates a manufacturing method according to the invention.

### DETAILED DESCRIPTION OF THE INVENTION

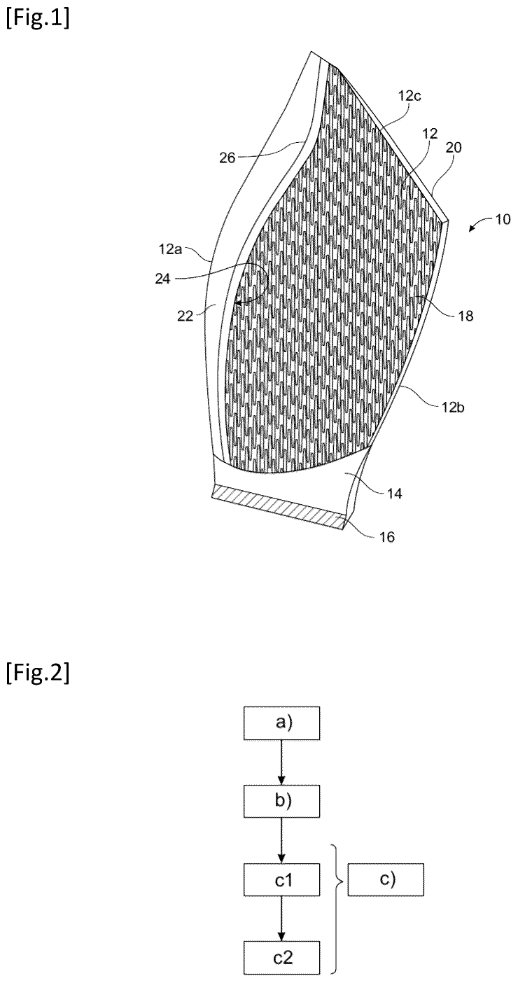

Reference is made to FIG. 1 which illustrates a composite material vane 10 for a turbomachine, this vane 10 being, for example, a fan vane or a secondary flow straightener vane in the case of a turbofan engine.

The vane 10 comprises a blade 12 connected by a stilt 14 to a root 16 which is for example dovetailed, and is shaped to engage in a recess of complementary shape in a rotor disc, in order to retain the vane on this disc.

The blade 12 comprises a leading edge 12a and a trailing edge 12b for the gases flowing in the turbomachine. The blade 12 comprises a curved or twisted aerodynamic profile and comprises a pressure side 18 and a suction side 20 extending between the leading edge 12a and the trailing edge 12b. The blade 12 also comprises an upper edge 12c opposite the root 16.

The blade 12 is made from a fibrous preform obtained by weaving fibers, for example carbon. The weave can be two-dimensional and preferably three-dimensional.

The leading edge 12a of the blade is reinforced and protected by a metal shield 22 which is fixed to this leading edge 12a. The shield 22 is made, for example, of a nickel-and cobalt-based alloy, in titanium, in stainless steel, etc.

The following description relates to the attachment of a shield 22 to a leading edge 12a. By analogy, it may be understood that the shield 22 or another shield could be attached to the trailing edge 12b. It may also be understood that the shield 22 or another shield could be attached to the top edge 12c. Furthermore, the shield provided on the trailing edge 12b, for example, could extend as far as the upper edge 12c for example, or the shields of the trailing edge 12b and upper edge 12c could be formed in a single part. Several variants are therefore conceivable with regards to the number and position of a shield within the meaning of the invention, even if the following description is made in relation to a shield located on the leading edge 12a of the blade 12.

In the present invention, the shield 22 is fixed firstly by co-molding the preform with the shield 22, and secondly by bonding the shield 22 using an adhesive 26.

FIG. 2 is a flow chart illustrating the steps in a method for manufacturing a composite vane 10 such as that shown in FIG. 1.

The method comprises steps a), b) and c).

The first step a) of the method involves making a fibrous preform by weaving fibers, preferably in three dimensions, using a Jacquard-type weaving machine for example. The resulting preform obtained is raw and may undergo operations such as cutting, shaping or compression, for example.

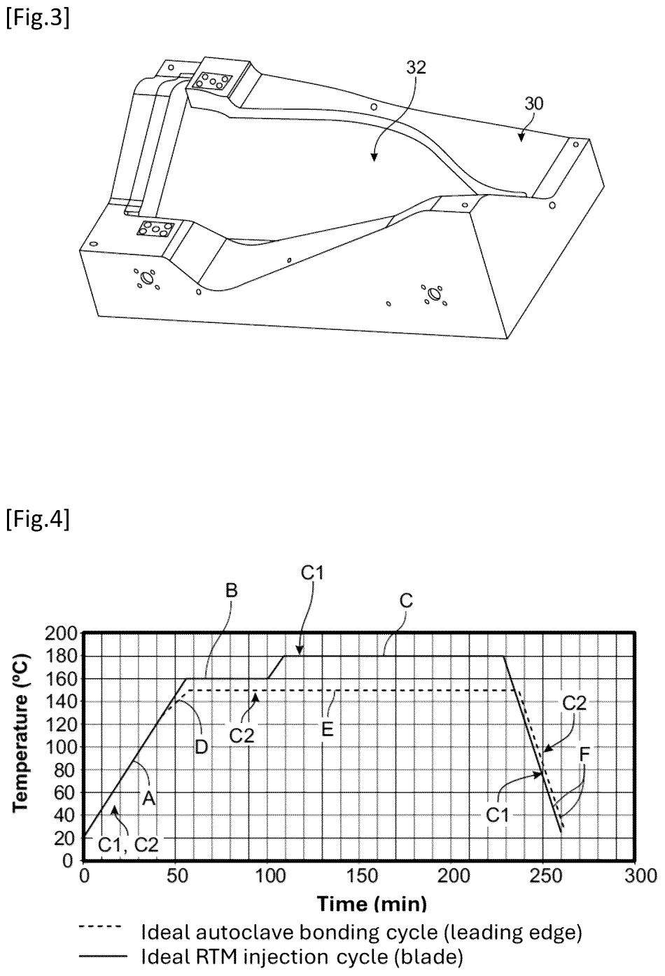

The first step a) also comprises depositing adhesive 26 between the shield 22 and the edge 12a of the preform 24 and then placing the assembly thus obtained in a mold 30 for manufacturing the vane, which is shown in FIG. 3. The adhesive 26 can be applied by brush or spray, for example. Alternatively, it can be in the form of a paste. Preferably, the adhesive is in the form of an adhesive film (such as a pre-impregnated fabric, for example) which is cut to the desired shape and then applied to the leading edge by the operator before the shield is paired with the leading edge.

Adhesive 26 is preferably an adhesive film consisting of a braided carrier impregnated with an epoxy-based thermosetting resin, for example marketed by 3M®, Hexcel® or Solvay.®

The shield 22 is generally dihedral in shape and defines a V-shaped groove into which an edge of the preform 24 is inserted. The adhesive 26 can be deposited in the groove of the shield 22 and/or on the edge of the preform 24.

The preform 24 fitted with the adhesive 26 and the shield 22 is then placed in the mold 30 (FIG. 3). This mold 30 forms part of a tooling which also includes a counter-mold (not shown). The mold 30 and the counter-mold have complementary shapes and define between them a cavity 32 for receiving the preform 24 and the shield 22. One portion or half of the cavity 32, intended for example to form the pressure side 18 of the blade 12, is formed in the mold 30, and the other portion or half of the cavity 32, intended for example to form the suction side 20 of the blade 12, is formed in the counter-mold.

In a step b), the tooling is closed by placing the counter-mold on the mold 30 and holding them tightly together, in particular to ensure that the cavity 32 is watertight. The method then comprises a step c) of temperature management of the tooling and injecting the polymerizable resin into the cavity of the tooling so that it impregnates the preform 24 so as to form the blade after solidification.

The management and in particular the heating of the tooling is carried out by temperature management elements. These management elements may form part of an oven or autoclave and/or may be directly integrated into the mold and/or counter-mold of the tooling.

The resin injected into the tooling is intended to impregnate the preform 24 and come into contact with the adhesive 26 of the shield 22. Once the resin has polymerized and hardened, the shield 22 is attached to the blade 12 using the adhesive 26 and the resin.

The vane 10 thus obtained, after polymerization of the resin, is advantageous in that its shield 22 is perfectly positioned and held on the blade 12.

The resin is, for example, an epoxy-based thermosetting resin, polyimide-based or bis-maleimide-based. These resins are commercially available.

The adhesive 26 and the resin are therefore made from two distinct materials with different temperature-dependent physico-chemical and rheological properties.

FIG. 4 is a graph showing two different tooling heating cycles. Heating cycles C2 shows the “ideal” cycle for a good behavior of the adhesive 26 and an optimized bonding of the shield 22 to the leading edge 12a. Heating cycle C1 shows the “ideal” cycle for optimum resin injection and diffusion in the cavity 32 of the tooling. It can be noticed that cycles C1, C2 each comprise a first part A of temperature rise which is similar (left-hand sloping part of cycles C1, C2), as well as a last part F of temperature drop which is also similar (right-hand sloping part of cycles C1, C2). However, cycles C1 and C2 have different holding temperature steps B, C and E. Cycle C1 comprises a first step B at 160° C. followed by a second step C at 180° C., whereas cycle C2 comprises a step D at 150° C. which is reached after a preliminary part D (just after the first part A) of temperature rise with a lower heating rate.

It can therefore be noticed that it would be preferable to optimize the heating of the tooling to take account of the different physico-chemical behaviors of the adhesive 26 and the resin. This is what the present invention proposes, with a tooling that allows to achieve this objective.

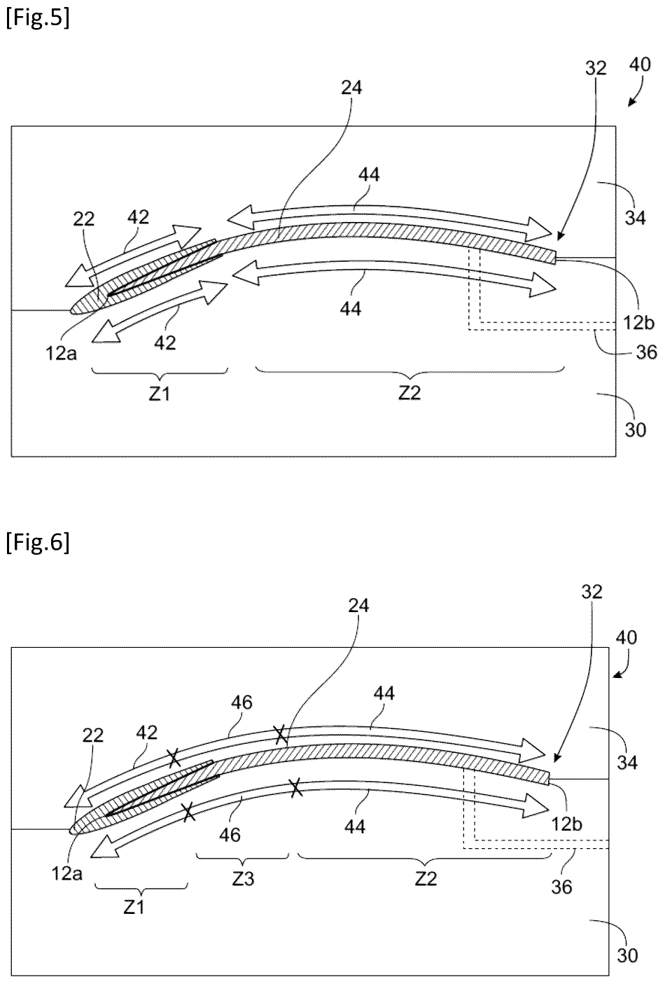

FIG. 5 illustrates very schematically a first embodiment of a tooling 40 according to the invention. This tooling 40 comprises:
a mold 30 and a counter-mold 34 which define between them a cavity 32 configured to receive a woven preform of the blade, such as that described above, the cavity 32 comprising a first portion Z1 configured to receive the shield 22 and the leading edge 12a of the preform, and a second portion Z2 configured to receive at least part of the remainder of the preform 24,
at least one port 36 for injecting resin into the cavity 32 of the tooling 40 in order to impregnate said preform 24, and
temperature management elements 42, 44 which are preferably integrated into the mold 30 and counter-mold 34.

According to the invention, the temperature management elements 42, 44 comprise first management elements 42 which are arranged at the first portion Z1 of the cavity 32, and second management elements 44 which are arranged at the second portion Z2 of the cavity 32 and which are independent of the first management elements 42.

As can be seen in the figure, the management elements 42, 44 are advantageously distributed in the mold 30 and the counter-mold 34.

In the example shown, the second management elements 44 are heating elements which are configured to heat the tooling 40 to a predetermined temperature, T1. T1 is, for example, greater than or equal to 160° C., and preferably greater than or equal to 180° C.

The first management elements 42 may be heating elements which are configured to heat the tooling 40 up to the temperature T1, during one step of a manufacturing method, and up to another predetermined temperature, T2, which is lower than T1, during another step of the manufacturing method. T2 is, for example, between 80 and 140° C., and preferably between 100 and 130° C.

Alternatively, these first management elements 44 could be cooling and heating elements which are configured to heat the tooling to the temperature T1, during one step of a manufacturing method, and to cool the tooling to the temperature T2, during another step of the manufacturing method.

In yet another variant, only the first elements 42 are integrated into the tooling and are cooling elements. The tooling 40 is intended to be placed in a heating press, oven or autoclave for heating. When the first elements 42 are activated by the circulation of a heat transfer fluid, the zone Z1 is cooled so as not to exceed the temperature T2 while the zone is heated to the temperature T1. When the first elements 42 are not activated, zones Z1 and Z1 are heated to temperature T1.

These management members can be electrical or fluidic. For example, they may be electric heating elements or induction systems (both of which can only heat), or heat transfer fluid pipes (which can heat or cool).

In the embodiment shown in FIG. 6, in addition to portions Z1 and Z2, the cavity 32 includes an intermediate portion Z3, located between the first and second portions Z1, Z2. The temperature management elements are configured to create a zone of gradual temperature transition at this intermediate portion Z3. This intermediate portion Z3 may be equipped with its own temperature management elements 46.

With reference to FIG. 2, the present invention also relates to a method of manufacturing a vane wherein step c) comprises:
c1) a first resin injection sub-step during which the second portion Z2 of the cavity 32 is heated to the temperature T1, and the first portion Z1 of the cavity 32 is managed so as not to exceed the temperature T2, and
c2) a second curing sub-step during which the first and second portions Z1, Z2 are heated to temperature T1.

During sub-step c1), the first portion Z1 of the cavity 32 may be heated to the predetermined temperature T2. Alternatively, the first portion Z1 of the cavity 32 is cooled so as not to exceed the predetermined temperature T2.

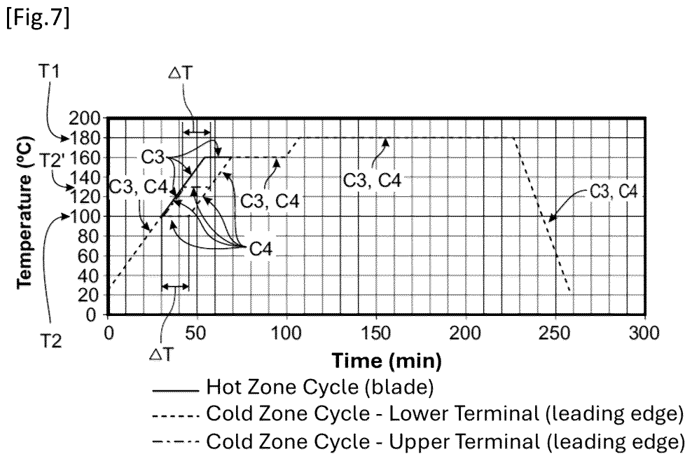

FIG. 7 is a graph showing two different heating cycles for tooling 40 in accordance with the invention.

The heating cycle C3 is the heating cycle carried out by the second management members 44 and therefore represents the heating cycle of the portion Z2 of the cavity 32 which does not include the shield 22 and the adhesive 26. By comparing this heating cycle C3 with the graph in FIG. 4, it can be noticed that this cycle corresponds to the ideal heating cycle C1 for injecting the resin.

The heating cycle C4 is the heating cycle carried out by the first management members 42 and therefore represents the heating cycle of the portion Z1 of the cavity 32 comprising the shield 22 and the adhesive 26. These cycles C3, C4 are superimposed except for the moment or time interval ΔT of resin injection and diffusion.

During this sub-step c1) the first portion Z1 of the cavity is heated and/or cooled to temperature T2. This temperature can vary and is 100° C. in the example shown for cycle C4, and 130° C. (temperature T2′) for a variant of this cycle C4′ shown in dotted lines.

The method according to the invention enables to keep the adhesive as cold as possible to prevent it from creeping when the resin is injected, while heating the rest of the cavity sufficiently to ensure that the resin is sufficiently liquid to optimize its diffusion. As these two constraints are in opposition, the invention provides a compromise by creating different temperature management zones in the tooling, which adds degrees of freedom to the definition of the heating cycle and therefore facilitates its development.

1. A tooling for manufacturing a vane made of composite material for a turbomachine, in particular of an aircraft, said vane comprising a blade comprising a pressure side and a suction side which extend from a leading edge to a trailing edge of the blade, the vane also comprising a root and an upper edge opposite its root, the vane further comprising at least one metal shield extending along at least one of said edges of the blade the tooling comprising:
a mold and a counter-mold which define between them a cavity configured to receive a woven preform of the blade the cavity comprising a first portion configured to receive the shield and the edge or edges of the preform intended to receive this shield and a second portion configured to receive at least part of the remainder of the preform,
at least one port for injecting resin into the cavity in order to impregnate said preform, and
elements for managing the temperature of the cavity,
wherein the temperature management elements comprise first elements for managing the temperature of the first portion of the cavity, and second elements for managing the temperature of the second portion of the cavity which are independent of the first temperature management elements so that the first and second management elements can heat the first and second portions of the cavity to different temperatures during at least one step of a method for manufacturing the vane.

2. The tooling according to claim 1, wherein the second temperature management elements are heating elements which are configured to heat the tooling to a predetermined temperature, noted T1.

3. The tooling according to claim 1, wherein the first temperature management elements are heating elements which are configured to heat the tooling to a predetermined temperature, noted T1, during a step of a manufacturing method, and to another predetermined temperature, noted T2 and lower than T1, during another step of the manufacturing method.

4. The tooling according to claim 1, wherein the first temperature management elements are cooling and heating elements which are configured to heat the tooling to a predetermined temperature, noted T1, during a step of a manufacturing method, and to cool the tooling to a predetermined temperature, noted T2 and lower than T1, during another step of the manufacturing method.

5. The tooling according to claim 1, wherein the cavity comprises an intermediate portion, located between the first and second portions, the temperature management elements being configured to create a zone of gradual temperature transition at this intermediate portion.

6. The tooling according to claim 1, wherein the temperature management elements are of the resistance heating, induction or heat transfer fluid circulation type.

7. The tooling according to claim 1, wherein the temperature management elements are distributed in the mold and the counter-mold.

8. The tooling according to one claim 1, wherein the temperature management elements are integrated in the mold and the counter-mold.

9. A method of manufacturing a composite material vane for a turbomachine, in particular of an aircraft, said vane comprising a blade comprising a pressure side and a suction side which extend from a leading edge to a trailing edge of the blade, the vane also comprising a root and an upper edge opposite its root, the vane further comprising at least one metal shield extending along at least one of said edges of the blade, the method using tooling according to claim 1 and comprising the steps of:
a) arranging a shield and a preform made by weaving fibers in the cavity of the tooling, a polymerizable adhesive being interposed between the shield and the edge or edges of the preform intended to receive the shield, the shield and the edge or edges of the preform being positioned in the first portion of the cavity, and the remainder of the preform being positioned in the second portion of the cavity,
b) closing the tooling, and
c) managing the temperature of the tooling and injecting polymerizable resin into the cavity of the tooling so that it impregnates the preform so as to form the blade after solidification,
wherein step c) comprises:
c1) a first resin injection sub-step during which the second portion of the cavity is heated to a predetermined temperature, noted T1, and the first portion of the cavity is managed so as not to exceed a predetermined temperature, noted T2, which is lower than T1, and
c2) a second curing sub-step during which the first and second portions are heated to temperature T1.

10. The method according to claim 9, wherein, in sub-step c1), the first portion of the cavity is heated to the predetermined temperature T2.

11. The method according to claim 9, wherein, in sub-step c1), the first portion of the cavity is cooled so as not to exceed the predetermined temperature T2.

12. The method according to claim 9, wherein the temperature T1 is greater than or equal to 160° C., and preferably greater than or equal to 180° C., and the temperature T2 is between 80 and 140° C., and preferably between 100 and 130°C.

13. The method according to claim 9, wherein the weaving of the preform is carried out in two dimensions or in three dimensions.
